(19) United States
(12) Patent Application Publication
(10) Pub. No.: US 2025/0377926 A1
(43) Pub. Date: Dec. 11, 2025

(54) TRANSACTION CONTROL SYSTEM, TRANSACTION CONTROL METHOD, AND PROGRAM

(71) Applicant: Hitachi, Ltd., Tokyo (JP)

(72) Inventors: Hideyuki SAKAI, Tokyo (JP); Yohsuke ISHII, Tokyo (JP)

(21) Appl. No.: 19/190,400

(22) Filed: Apr. 25, 2025

(30) Foreign Application Priority Data
Jun. 7, 2024 (JP) 2024-093198

(51) Int. Cl. G06F 9/46; G06F 11/07

(52) U.S. Cl. CPC G06F 9/466; G06F 11/0709; G06F 11/079

(57) ABSTRACT

Provided is a transaction control system, method, and program that suppress Rollback processing of a transaction, which is undecided due to a system failure, after system restart. The transaction control system includes: an orchestrator that generates a Try request for confirming whether to execute a transaction, the transaction being a series of processing generated by a request from a user, before causing a plurality of external servers to respectively execute the transaction; and a plurality of proxy devices provided correspondingly to the plurality of external servers, the plurality of proxy devices each respectively recording a flag indicating progress of a processing flow including generation of the Try request through decision of the transaction for corresponding one of undecided transaction in accordance with the progress. The plurality of proxy devices each determine whether to continue the processing of corresponding transaction among the undecided transaction based on the flag after restart.

### CROSS REFERENCE TO RELATED APPLICATIONS

This application claims priority to Japanese Patent Application No. 2024-093198, filed Jun. 7, 2024, the contents of which are incorporated herein by reference in its entirety for all purposes.

### TECHNICAL FIELD

The present disclosure relates to transaction control.

### BACKGROUND ART

A plurality of servers executes a series of processing in cooperation between microservices or in cooperation between an application and an external service group, thereby providing a plurality of services to users. In this case, consistency of a series of processing related to a plurality of services is important. When any of all the processing of the plurality of services fails during execution, it is necessary to return to all the processing to a state before the execution of the processing. As a technique for securing the consistency of the results of such a series of processing, a distributed transaction technique is known.

Although there exist many techniques regarding the distributed transactions, a technique called Try, Confirm, Cancel (TCC) is known as a technique suitable for cooperation with external services. A TCC flow, which is a flow of TCC processing, includes two phases called two-phase commit. The two-phase commit includes a Try phase and a Confirm or Cancel phase. In the Try phase, resource update is reserved for each of a plurality of services. If all the services can be reserved in the Try phase, the Confirm phase is selected and the resource update is confirmed. If any of the plurality of services cannot be reserved in the Try phase, the Cancel phase is selected even if the other services can be reserved. Thus, the reservation of all the services is canceled.

In a case where the distributed transaction is executed between a plurality of devices via a network, it is difficult to keep track of the progress of processing. Therefore, when a failure occurs in a system that controls a transaction, the system often selects Rollback for starting transaction processing over from the beginning. Many failures of the transaction processing increase the selection of the Cancel phase in the case of the TCC flow. Further, in a case of cooperating with an external service in which processing specification cannot be specified, the Rollback may take time. Therefore, it is desirable to proceed the TCC flow to Rollforward for executing the processing reserved in the Try phase as much as possible.

An example of a distributed transaction system is disclosed (see, for example, PTL 1). This system applies the TCC flow to processing of the distributed transaction and manages a state of the distributed transaction to be processed. The distributed transaction system disclosed in PTL 1 manages the start and update completion of the distributed transaction, and selects Commit or Rollback with reference to the state of the transaction when a failure occurs in the system.

PTL 2 discloses an example of a distributed transaction processing device that manages a state of a transaction to be processed in detail as compared with the system disclosed in PTL 1. The distributed transaction processing device disclosed in PTL 2 manages three or more states such as a transaction in execution, a transaction success, and a transaction failure. Further, as another technique, a system is disclosed in which transaction recovery information and an undecided transaction are matched, and Commit or Rollback corresponding to Rollforward is selected for the undecided transaction (see, for example, PTL 3).

### CITATION LIST

### Patent Literature

PTL 1: JP 2007-025982 A

PTL 2: CN 114371918 A

PTL 3: JP 2015-514247 A

### SUMMARY OF INVENTION

### Technical Problem

Since the system disclosed in PTL 1 manages only the states of the start and update completion of the transaction, it is necessary to roll back all the transactions in processing if a system failure occurs. Although the device disclosed in PTL 2 can manage the state more finely than the system disclosed in PTL 1, the load of the state management increases. In this case, when a plurality of transactions is processed in parallel, the management load increases in proportion to the number of undecided transactions. Further, PTL 3 does not disclose details of the transaction recovery information, and it is unclear how to reflect the state of an undecided transaction in the recovery information. In any system, it is difficult to suppress the Rollback processing of the undecided transaction while suppressing the load of the state management of the undecided transaction.

One object included in the present disclosure is to provide a transaction control system, a transaction control method, and a program that suppress Rollback processing of a transaction, which is undecided due to a system failure, after system restart.

### Solution to Problem

A transaction control system according to one aspect included in the present disclosure includes an orchestrator that generates a Try request for confirming whether to execute a transaction, the transaction being a series of processing generated based on a request from a user, before causing a plurality of external servers to execute the transaction, and a plurality of proxy devices provided correspondingly to the plurality of external servers, the plurality of proxy devices each recording a flag indicating progress of a processing flow including generation of the Try request through decision of the transaction for each undecided transaction in accordance with the progress, wherein the plurality of proxy devices each determine whether to continue the processing of the undecided transaction based on the flag after restarting.

### Advantageous Effects of Invention

According to one aspect included in the present disclosure, the flag indicating progress during the processing flow including the generation of the Try request through the decision of the transaction is recorded for the undecided transaction in accordance with the progress. Since the state during the undecided transaction is more finely recorded in the flag, the undecided transaction is more likely to be rolled forward due to the progress recorded in the flag at the time of system restart. As a result, the processing for rolling back the undecided transaction is suppressed.

### BRIEF DESCRIPTION OF DRAWINGS

FIG. 1 is a block diagram illustrating one configuration example of a transaction control system according to a first embodiment.

FIG. 2 is a block diagram illustrating one configuration example of a proxy device in the transaction control system illustrated in FIG. 1.

FIG. 3 is a diagram illustrating one example of a parameter list managed by a parameter management unit.

FIG. 4 is a diagram illustrating one example of an undecided transaction list managed by the parameter management unit.

FIG. 5 is a block diagram illustrating one example of a hardware configuration of the transaction control system illustrated in FIG. 1.

FIG. 6 is a sequence diagram illustrating one example of overall processing of a Try, Confirm, Cancel (TCC) flow by the transaction control system of the first embodiment.

FIG. 7 is a sequence diagram illustrating first half processing of the TCC flow executed in the proxy device.

FIG. 8 is a sequence diagram illustrating the latter half processing of the TCC flow executed in the proxy device.

FIG. 9 is a flowchart illustrating an operation procedure of the transaction control system with respect to an undecided transaction in a case where a flag indicates any of Try, TryOK, or TryNG when the proxy device is restarted.

FIG. 10 is a flowchart illustrating an operation procedure of the transaction control system with respect to an undecided transaction in a case where the flag indicates Commit or Rollback when the proxy device is restarted.

FIG. 11 is a flowchart illustrating an operation procedure of the transaction control system with respect to an undecided transaction in a case where the flag indicates Confirm or Cancel when the proxy device is restarted.

FIG. 12 is a block diagram illustrating one configuration example of a transaction control system according to a second embodiment.

FIG. 13 is a flowchart illustrating an operation procedure of a Commit or Rollback determination unit in the transaction control system according to the second embodiment.

### DESCRIPTION OF EMBODIMENTS

In the present embodiment, as one example of a system that controls a transaction, a system that is applied to basic office operations and has a distributed agreement determination function is described. Further, the present embodiment describes a case where the technique of a Try, Confirm, Cancel (TCC) flow is applied to the transaction control, but the present disclosure is not limited to the case of the application of the TCC flow. Hereinafter, a transaction control system of the present embodiment is described.

### First Embodiment

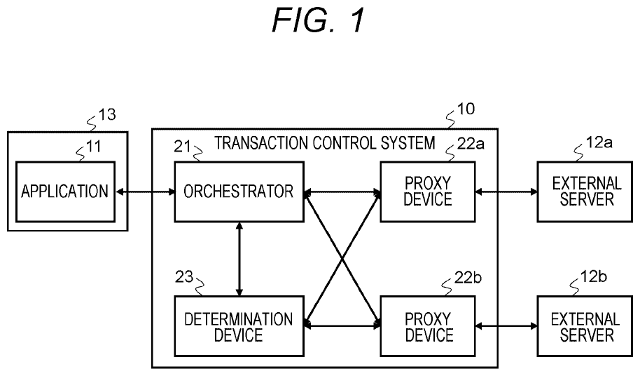

A configuration of the transaction control system of the first embodiment is described with reference to the drawings. In the drawings referred to, the same components are denoted by the same reference numerals. FIG. 1 is a block diagram illustrating one configuration example of the transaction control system according to the first embodiment.

As illustrated in FIG. 1, the transaction control system 10 is connected to an external server 12a, an external server 12b, and an information processing terminal 13. The external server 12a is an information processing apparatus that provides an external service A to a user. The external server 12b is an information processing apparatus that provides an external service B to a user. The information processing terminal 13 is an information processing apparatus operated by a user. The information processing terminal 13 is, for example, a smartphone or a personal computer (PC). The transaction control system 10 is connected to the information processing terminal 13, the external server 12a, and the external server 12b via a network. The network is, for example, a network including the Internet.

The information processing terminal 13 stores an application software program (hereinafter, referred as an application) 11. The information processing terminal 13 executes the application 11 and transmits an application programming interface (API) request corresponding to an instruction input by the user to the transaction control system 10. The transaction control system 10 generates a transaction that is a series of processing in response to the API request received from the application 11, and controls a transaction derived from the transaction and transmitted and received between the two external servers, i.e. the external server 12a and the external server 12b.

For example, in a case where the application 11 is an application for travel reservation, the external service A is a service for reserving transportation means such as trains or airplanes, and the external service B is a service for reserving accommodation facilities such as inns or hotels. The transaction of a series of processing related to the reservation is generated from the API request regarding the travel reservation. A transaction regarding the reservation processing of transportation means, and a transaction regarding the reservation processing of accommodation facilities are derived from the generated transaction. When all these transactions are decided, the user can reserve travel transportation and accommodations together.

In the transaction control system 10, the TCC flow is applied to the transaction control in order to ensure data consistency due to idempotence and eventual consistency. The transaction control system 10 transmits a request corresponding to each phase of a two-phase commit to the external server 12a and the external server 12b. For example, in the Try phase of the two-phase commit, the transaction control system 10 transmits a Try request to the external server 12a and the external server 12b. In the Confirm/Cancel phase of the two-phase commit, the transaction control system 10 transmits a Confirm request or a Cancel request to the external server 12a and the external server 12b.

The Try request is to request confirmation as to whether a target transaction can be executed. The Confirm request is to request execution of a target transaction. The Cancel request is to request cancellation of a target transaction without executing the transaction.

A configuration of the transaction control system 10 is described with reference to FIG. 1. The transaction control system 10 includes an orchestrator 21, a proxy device 22a, a proxy device 22b, and a determination device 23. The orchestrator 21, the proxy device 22a, the proxy device 22b, and the determination device 23 are connected to each other via a network.

Upon receiving the API request from the application 11, the orchestrator 21 transmits the Try request to the proxy device 22a and the proxy device 22b. Upon receiving responses to the Try requests from the proxy device 22a and the proxy device 22b, the orchestrator 21 instructs the determination device 23 to make a distributed agreement determination.

Upon receiving the Try request from the orchestrator 21, the proxy device 22a transmits the Try request to the external server 12a corresponding to the proxy device 22a. The proxy device 22a receives a response to the Try request from the external server 12a. The proxy device 22a transmits the response to the Try request to the orchestrator 21. The proxy device 22a performs a Commit vote on the determination device 23 when the result of the received response is OK, and performs a Rollback vote on the determination device 23 when the result of the response is NG. Commit voting means that provisional execution of the transaction is successful. Rollback voting means that the provisional execution of the transaction fails and a state is returned to before the provisional execution of the transaction. Upon receiving a notification of the Confirm from the determination device 23 as the distributed agreement determination result, the proxy device 22a transmits the Confirm request to the external server 12a. Upon receiving a notification of Cancel from the determination device 23 as the distributed agreement determination result, the proxy device 22a transmits the Cancel request to the external server 12a.

Upon receiving the Try request from the orchestrator 21, the proxy device 22b transmits the Try request to the external server 12b corresponding to the proxy device 22b. The proxy device 22b receives a response to the Try request from the external server 12b. The proxy device 22b transmits the response to the Try request to the orchestrator 21. The proxy device 22b performs the Commit vote on the determination device 23 when the result of the received response is OK, and performs the Rollback vote on the determination device 23 when the result of the response is NG. Upon receiving a notification of the Confirm from the determination device 23 as the distributed agreement determination result, the proxy device 22b transmits the Confirm request to the external server 12b. Upon receiving a notification of Cancel from the determination device 23 as the distributed agreement determination result, the proxy device 22b transmits the Cancel request to the external server 12b.

Upon receiving votes corresponding to the responses to the Try requests from the proxy device 22a and the proxy device 22b, respectively, and receiving an instruction to make the distributed agreement determination from the orchestrator 21, the determination device 23 makes the distributed agreement determination. An example of the distributed agreement determination is described. In a case where all the votes received from the proxy device 22a and the proxy device 22b are Commit, the determination device 23 determines Confirm meaning that a target transaction may be executed. On the other hand, in a case where the votes received from the proxy device 22a and the proxy device 22b include even one Rollback, the determination device 23 determines as Cancel meaning that the target transaction is cancelled without executing the target transaction. The determination device 23 transmits a notification of Confirm or Cancel to the proxy device 22a and the proxy device 22b as the result of the distributed agreement determination.

Note that, in the first embodiment, as illustrated in FIG. 1, a case where the plurality of external servers are two external servers, that is, the external server 12a and the external server 12b is described, but the number of the external servers may be three or more. The number of the proxy devices provided in the transaction control system 10 may be increased in accordance with the number of the external servers. Further, although the case where the determination device 23 illustrated in FIG. 1 outputs one determination result has been described, the determination device 23 may have a configuration including a plurality of determination units in order to ensure fault tolerance. In a case where the determination device 23 includes the plurality of determination units, determination results in the plurality of determination units may be different. In this case, in order to uniquely determine the Confirm or Cancel, the proxy device 22a and the proxy device 22b make an auxiliary agreement to determine or agree on Confirm or Cancel. After making the auxiliary agreement, the proxy device 22a and the proxy device 22b transmit the auxiliary agreement results to the determination device 23.

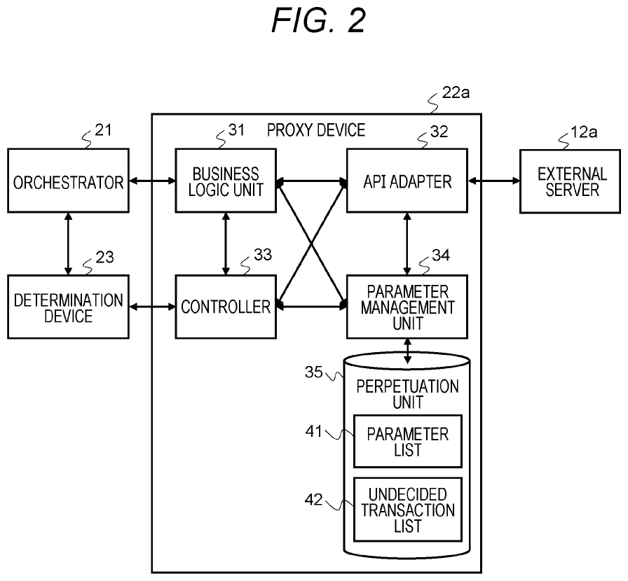

FIG. 2 is a block diagram illustrating one configuration example of the proxy device in the transaction control system illustrated in FIG. 1. FIG. 2 illustrates a configuration example of the proxy device 22a out of the proxy device 22a and the proxy device 22b, and illustration of the configuration example of the proxy device 22b is omitted. Since the configuration of the proxy device 22b is similar to that of the proxy device 22a illustrated in FIG. 2, a detailed description thereof is omitted.

As illustrated in FIG. 2, the proxy device 22a includes a business logic unit 31, an API adapter 32, a controller 33, a parameter management unit 34, and a perpetuation unit 35. The perpetuation unit 35 stores a parameter list 41 and an undecided transaction list 42. Note that the parameter management unit 34 and the perpetuation unit 35 may be provided outside the proxy device 22a.

Upon receiving the Try request from the orchestrator 21, the business logic unit 31 saves a parameter group such as service parameters assigned to the received Try request in the perpetuation unit 35 via the parameter management unit 34. The business logic unit 31 records the progress of the TCC flow of the undecided transaction in in the undecided transaction list 42 of the perpetuation unit 35 via the parameter management unit 34. Specifically, the business logic unit 31 records a flag indicating a progress in accordance with the progress of the TCC flow for each undecided transaction in association with an identifier (ID) of the undecided transaction. The business logic unit 31 transmits an instruction to implement the Try request to the API adapter 32. Upon receiving the response to the Try request from the API adapter 32, the business logic unit 31 notifies the controller 33 of the response. The business logic unit 31 transmits, to the orchestrator 21, the response to the Try request.

Upon receiving an instruction to implement the Try request from the business logic unit 31, the API adapter 32 reads a parameter group necessary for the Try request from the perpetuation unit 35 via the parameter management unit 34, and transmits the Try request including the read parameter group to the external server 12a. The API adapter 32 records the progress of the undecided transaction in the TCC flow in accordance with the response to the Try request in the undecided transaction list 42 of the perpetuation unit 35 via the parameter management unit 34. Upon receiving an instruction to implement the Confirm request or the Cancel request from the controller 33, the API adapter 32 reads a parameter group necessary for the instructed request from the perpetuation unit 35 via the parameter management unit 34, and transmits the request including the read parameter group to the external server 12a. Upon receiving an instruction to implement initialization processing after restart of the proxy device 22a from the controller 33, the API adapter 32 reads the undecided transaction list 42 from the perpetuation unit 35 via the parameter management unit 34.

Upon receiving a result of the Try request from the business logic unit 31, the controller 33 performs the Commit or Rollback vote on the determination device 23. Upon receiving a result of the distributed agreement determination from the determination device 23, the controller 33 records the progress in the TCC flow of the undecided transaction corresponding to the result of the distributed agreement determination, in the undecided transaction list 42 of the perpetuation unit 35 via the parameter management unit 34. The controller 33 transmits an instruction to implement the Confirm request or the Cancel request to the API adapter 32 in accordance with the result of the distributed agreement determination by the determination device 23. The controller 33 transmits an instruction to execute the initialization processing after restart of the proxy device 22a to the API adapter 32.

In accordance with the instruction from each unit in the proxy device 22a, the parameter management unit 34 reads the parameter group or the undecided transaction list 42 saved in the perpetuation unit 35 from the perpetuation unit 35, and provides the parameter group or the undecided transaction list 42 to each unit. The parameter management unit 34 saves, in the perpetuation unit 35, the parameter group, ID of the undecided transaction, and information about the progress in the TCC flow received from each unit in the proxy device 22a. The parameter management unit 34 updates and deletes the information saved in the perpetuation unit 35 in accordance with the instruction from each unit in the proxy device 22a.

The perpetuation unit 35 stores a parameter group necessary for each of the Try request, the Confirm request, and the Cancel request. The parameter list 41 is a list of an ID of a transaction and a parameter group necessary for processing of the transaction. The undecided transaction list 42 is a list of the ID of the undecided transaction and the progress in the TCC flow. The perpetuation unit 35 includes, for example, a database.

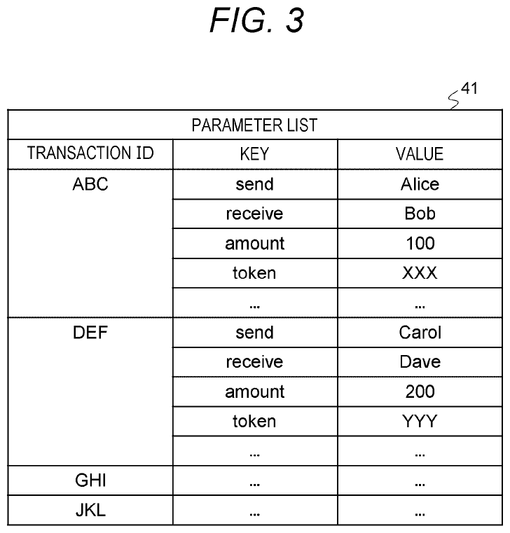

FIG. 3 is a diagram illustrating one example of the parameter list managed by the parameter management unit. A combination of a transaction ID, a key of a parameter, and a value is recorded in the parameter list 41. For each transaction ID, a parameter is added as needed in accordance with the progress in the TCC flow. All the parameters are deleted when the TCC flow is completed.

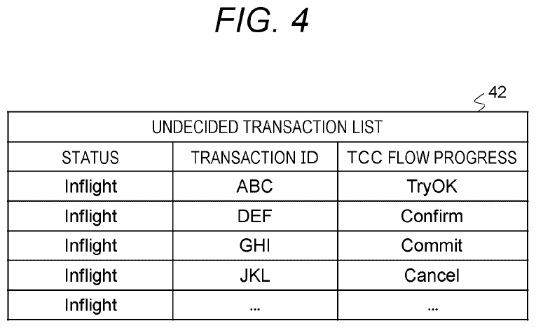

FIG. 4 is a diagram illustrating one example of an undecided transaction list managed by the parameter management unit. In the undecided transaction list 42, a combination of a transaction ID and a flag indicating progress in the TCC flow is recorded for each transaction whose status is Inflight (undecided). In accordance with the progress of the undecided transaction in the TCC flow, the value of the flag of the same set having ID identical to the transaction ID of the undecided transaction is updated as the need arises. When the TCC flow is completed, that is, the transaction is decided, the combination of the transaction ID and the flag of the undecided transaction is deleted from the undecided transaction list 42.

The flag is a value of Try, TryOK, TryNG, Commit, Rollback, Confirm, or Cancel, in accordance with the progress in the TCC flow. Try indicates that the proxy device has transmitted the Try request to the external server. TryOK is a response from the external server to the proxy device with respect to the Try request, and indicates that the external server can execute a transaction. TryNG is a response from the external server to the proxy device with respect to the Try request, and indicates that the external server cannot execute a transaction. Commit indicates contents of the Commit vote performed on the determination device 23 by the proxy device. Rollback indicates contents of the Rollback vote performed on the determination device 23 by the proxy device. Confirm indicates that an instruction to execute a target transaction has been received. Cancel indicates that an instruction to cancel a target transaction has been received.

Among the above flags, for example, “TryOK” and “TryNG” correspond to the responses to the Try request. In addition, “Confirm” and “Cancel” correspond to the distributed agreements determination result by the determination device. In this manner, the response to the Try request, the contents of the voting on the determination device 23, and the determination result by the determination device 23 are reflected in the flag as the progress in the TCC flow.

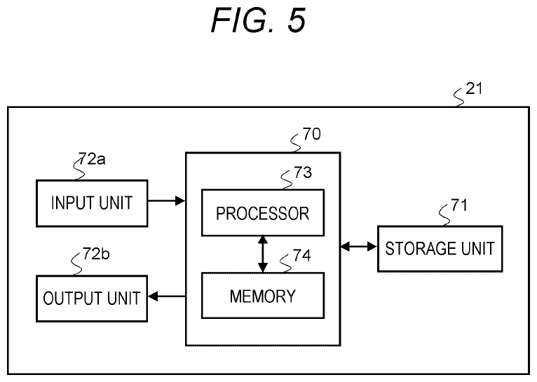

Here, a configuration of the transaction system 10 is described. FIG. 5 is a block diagram illustrating one example of a hardware configuration of a plurality of devices configuring the transaction control system illustrated in FIG. 1. A hardware configuration of the orchestrator 21 among the orchestrator 21, the proxy device 22a, the proxy device 22b, and the determination device 23 will be described.

As illustrated in FIG. 5, the orchestrator 21 includes a control unit 70, a storage unit 71, an input unit 72a, and an output unit 72b. The storage unit 71 is, for example, a storage device such as a hard disk drive (HDD) or a solid state drive (SSD). The control unit 70 includes a memory 74 that stores a program and a processor 73 that executes processing in accordance with the program. The processor 73 is, for example, a central processing unit (CPU). A function of the orchestrator 21 is executed by the processor 73 to execute the program. In the case of the first embodiment, the program executed by the processor 73 corresponds to middleware that controls a transaction.

In the first embodiment, the input unit 72a and the output unit 72b function as communication units that transmit and receive data to and from other devices via a network. For example, the input unit 72a and the output unit 72b each include a communication circuit that transmits and receives data in accordance with a communication protocol such as Internet Protocol (IP). The input unit 72a may have input devices such as a keyboard and a mouse operated by an administrator of the transaction control system 10. The output unit 72b may have a display for providing information to the administrator of the transaction control system 10.

Further, some or all of the functions of the orchestrator 21 may be executed by a dedicated circuit such as an application specific integrated circuit (ASIC). Note that the hardware of the proxy device 22a, the proxy device 22b, and the determination device 23 is similar to that of the orchestrator 21 described with reference to FIG. 5, and thus a detailed description thereof is omitted. Further, each of the orchestrator 21, the determination device 23, the proxy device 22a, and the proxy device 22b illustrated in FIG. 1 may be configured as a component in a single information processing apparatus.

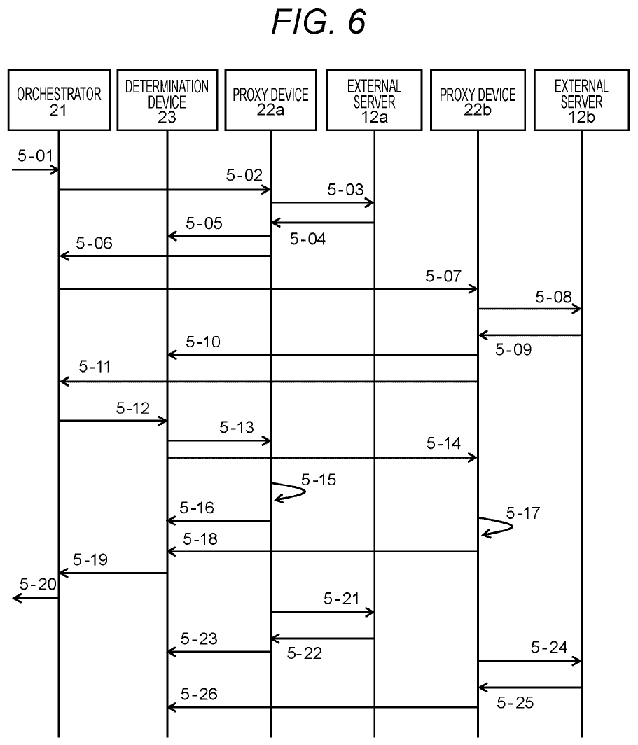

Next, the transaction control system according to the first embodiment is described. FIG. 6 is a sequence diagram illustrating one example of overall processing of the TCC flow executed by the transaction control system of the first embodiment. FIG. 6 illustrates a processing flow between the component groups illustrated in FIG. 1, and does not illustrate the application 11.

In step 5-01, the application 11 transmits an API request to the orchestrator 21. Data necessary for the processing in and after step 5-01 is added to the API request. For example, a service parameter for accessing an external server is described in the body of the API request. A token for accessing an external server is set in the header of the API request. In step 5-02, the orchestrator 21 transmits the Try request to the proxy device 22a. In the body of the Try request, a service parameter for accessing the external server 12a is described based on the service parameter input in step 5-01. In the header of the Try request, a token for accessing the external server 12a, an idempotence ID for securing the idempotence of the Try y request, and a transaction ID for uniquely distinguishing transactions are set.

In step 5-03, the proxy device 22a transmits the Try request to the external server 12a. The Try request includes various parameter groups described in the body in step 5-02 and set in the header. In step 5-04, the proxy device 22a receives a response to the Try request from the external server 12a. In step 5-05, the proxy device 22a performs the Commit vote on the determination device 23 in a case where the response to the Try request is OK, and performs the Rollback vote on the determination device 23 in a case where the response to the Try request is NG. In step 5-06, the orchestrator 21 receives a response to the Try request from the proxy device 22a.

In steps 5-07 to 5-11, the processing for the external server 12b is executed similarly to steps 5-02 to 5-06 of the external server 12a. Since the processing in steps 5-07 to 5-11 is similar to the processing in steps 5-02 to 5-06, the detailed description thereof is omitted.

In step 5-12, upon receiving the responses to the Try request from all the proxy devices, the orchestrator 21 transmits an instruction to make a distributed agreement determination to the determination device 23. In step 5-13, the determination device 23 makes a distributed agreement determination and notifies the proxy device 22a of the determination result. In step 5-14, the determination device 23 notifies the proxy device 22b of the determination result. The determination result is Confirm or Cancel. Hereinafter, a case where the determination result is Confirm is described. In a case where the determination device 23 includes a plurality of determination units, auxiliary agreement processing is performed between the proxy device 22a and the proxy device 22b in steps 5-15 and 5-17. In step 5-16, the proxy device 22a transmits the auxiliary agreement result to the determination device 23. In step 5-18, the proxy device 22b transmits the auxiliary agreement result to the determination device 23.

In step 5-19, the determination device 23 transmits the determination result to the orchestrator 21. In step 5-20, the orchestrator 21 transmits a response to the application 11. In step 5-21, the proxy device 22a transmits the Confirm request to the external server 12a. Necessary parameters are set in the body and header of the Confirm request. In step 5-22, the proxy device 22a receives a response to the Confirm request. In step 5-23, the proxy device 22a transmits a result of the Confirm request to the determination device 23. Since the processing in steps 5-24 to 5-26 is similar to the processing in steps 5-21 to 5-23, the detailed description thereof is omitted.

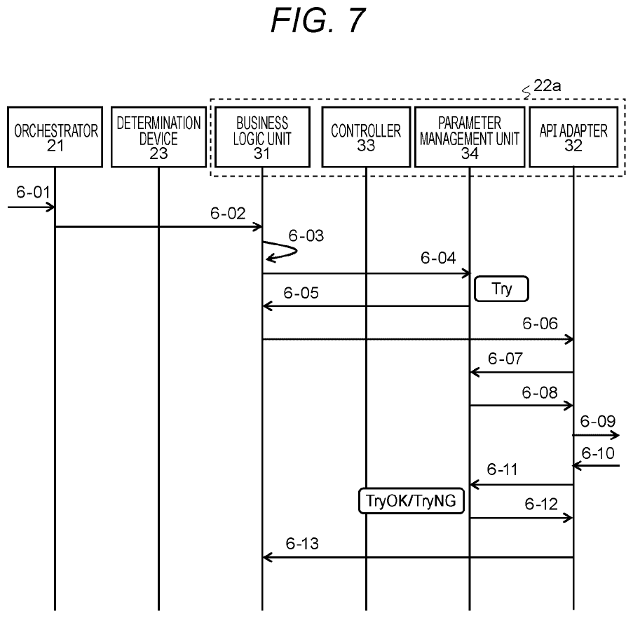

Next, the contents of processing executed by the components constituting the proxy device for the first half flow in the TCC flow illustrated in FIG. 6 are described in detail. Here, a case of the proxy device 22a will be described. FIG. 7 is a sequence diagram illustrating the first half processing of the TCC flow executed in the proxy device. FIG. 7 is a processing flow between the component groups of the proxy device illustrated in FIG. 2, and does not illustrate the application 11 and the external server 12a.

In step 6-01, the application 11 transmits an API request to the orchestrator 21 similarly to step 5-01. In step 6-02, the orchestrator 21 transmits the Try request to the business logic unit 31. A service parameter for accessing the external server 12a is described in the body of the request, and a token for accessing the external server 12a and a transaction ID for uniquely distinguishing transactions are set in the header. In step 6-03, the business logic unit 31 generates an idempotence ID for securing idempotence for an access to the external server 12a. In steps 6-04 and 6-05, the business logic unit 31 saves the service parameter, the token, and the idempotence ID in the parameter list 41 in the perpetuation unit 35 in association with the transaction ID via the parameter management unit 34. In addition, the business logic unit 31 adds a flag “Try” to the transaction ID and records the flag “Try” in the undecided transaction list 42 in association with the transaction ID.

In step 6-06, the business logic unit 31 notifies the API adapter 32 of an instruction to execute the Try request. In steps 6-07 and 6-08, the API adapter 32 reads the parameter group saved in the perpetuation unit 35 in association with the transaction ID via the parameter management unit 34. In step 6-09, the API adapter 32 transmits the Try request to the external server 12a. In step 6-10, the API adapter 32 receives a response to the Try request from the external server 12a. In steps 6-11 and 6-12, the API adapter 32 refers to the undecided transaction list 42 saved in the perpetuation unit 35 via the parameter management unit 34, and updates the flag saved corresponding to the ID of the target transaction based on the result of the response to the Try request. Specifically, when the response to the Try request is OK, the API adapter 32 updates the flag “Try” to the flag “TryOK”. On the other hand, when the response to the Try request is NG, the API adapter 32 updates the flag “Try” to the flag “TryNG”. In step 6-13, the API adapter 32 transmits the response to the Try request to the business logic unit 31.

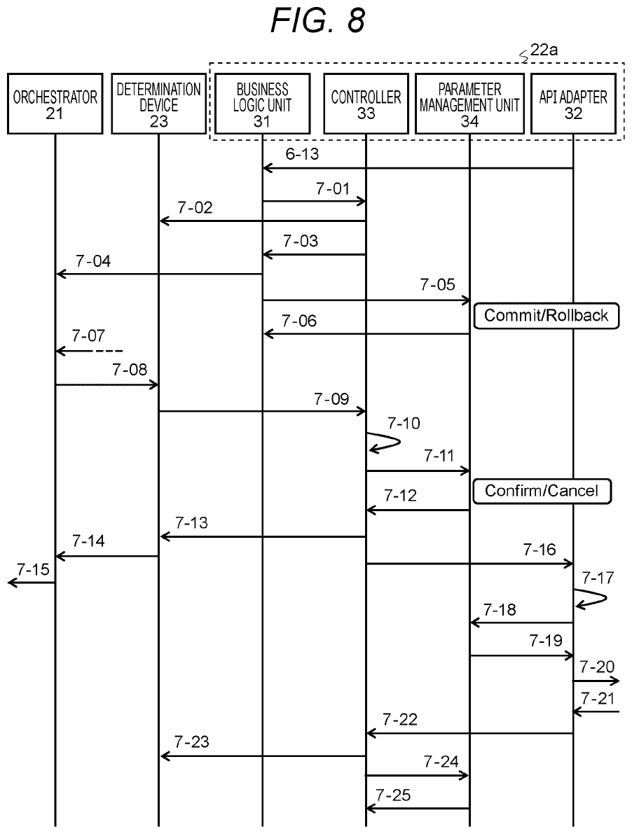

Next, the contents of processing executed by the components constituting the proxy device for the latter half flow in the TCC flow illustrated in FIG. 6 are described in detail. Here, the case of the proxy device 22a will be described. FIG. 8 is a sequence diagram illustrating the latter half processing of the TCC flow executed in the proxy device. FIG. 8 is a processing flow between the component groups of the proxy device illustrated in FIG. 2, and does not illustrate the application 11 and the external server. FIG. 8 is a processing flow continuing from the processing in step 6-13 illustrated in FIG. 7.

In step 7-01, the business logic unit 31 transmits the result of the Try request to the controller 33. In step 7-02, the controller 33 transmits the vote corresponding to the result of the Try request to the determination device 23. Specifically, the controller 33 transmits the Commit vote to the determination device 23 when the result of the Try request is OK, and transmits the Rollback vote to the determination device 23 when the result of the Try request is NG. In step 7-03, the controller 33 returns a return with respect to the processing in step 7-01 to the business logic unit 31. In step 7-04, the business logic unit 31 transmits the response to the Try request to the orchestrator 21.

In steps 7-05 and 7-06, the business logic unit 31 updates the flag in accordance with the content of the voting as for the undecided transaction. Specifically, in a case where the Commit voting is performed, the business logic unit 31 updates the flag corresponding to the ID of the undecided transaction in the undecided transaction list 42 saved in the perpetuation unit 35 to Commit via the parameter management unit 34. On the other hand, in a case where the Rollback voting is performed, the business logic unit 31 updates the flag corresponding to the ID of the undecided transaction in the undecided transaction list 42 saved in the perpetuation unit 35 to Rollback via the parameter management unit 34. In step 7-07, all the other proxy devices transmit the response to the Try request to the orchestrator 21. In the first embodiment, the proxy device 22b transmits the response to the Try request to the orchestrator 21.

In step 7-08, the orchestrator 21 instructs the determination device 23 to make a distributed agreement determination. The determination device 23 makes the distribution agreement determination. In step 7-09, as a result of the distributed agreement determination, the determination device 23 transmits, to the controller 33, a notification instructing to perform a Confirm or notification instructing to perform Cancel. Here, a case where the result of the distributed agreement determination is Confirm is described. In step 7-10, the controller 33 implements an auxiliary agreement in cooperation with another proxy device. Here, a case where the result of the auxiliary agreement is Confirm is described.

In steps 7-11 and 7-12, the controller 33 updates the flag of the undecided transaction based on the content instructed from the determination device 23. Specifically, when the content instructed from the determination device 23 is the Confirm, the controller 33 updates the value of the flag of the same combination as the undecided transaction ID of the undecided transaction list 42 saved in the perpetuation unit 35 to Confirm via the parameter management unit 34. On the other hand, when the content instructed from the determination device 23 is the Cancel, the controller 33 updates the value of the flag of the same combination as the undecided transaction ID of the undecided transaction list 42 saved in the perpetuation unit 35 to Cancel via the parameter management unit 34.

In step 7-13, the controller 33 transmits a final agreement result to the determination device 23. In step 7-14, the determination device 23 transmits the final agreement result to the orchestrator 21. In step 7-15, the orchestrator 21 transmits a response to the API request to the application 11.

In step 7-16, the controller 33 transmits an instruction to perform the Confirm to the API adapter 32. In step 7-17, the API adapter 32 generates the idempotence ID required for the Confirm request for the external server 12a.

In steps 7-18 and 7-19, the API adapter 32 saves the idempotence ID for the Confirm request generated in step 7-17 in the perpetuation unit 35 via the parameter management unit 34 in association with the ID of the target transaction. Further, the API adapter 32 reads a parameter group saved in association with the ID of the target transaction. In step 7-20, the API adapter 32 transmits the Confirm request to the external server 12a. In step 7-21, the API adapter 32 receives a response to the Confirm request from the external server 12a.

In step 7-22, the API adapter 32 transmits the result of the Confirm request to the controller 33. In step 7-23, the controller 33 transmits information indicating that the target transaction has been decided to the determination device 23. In steps 7-24 and 7-25, the controller 33 refers to the parameter list 41 saved in the perpetuation unit 35 via the parameter management unit 34, and deletes the parameter group saved in association with the ID of the decided transaction from the perpetuation unit 35. Further, the controller 33 deletes the ID of the decided transaction and the flag corresponding to the ID from the undecided transaction list 42.

As described above, a flag indicating the progress is given to the undecided transaction in accordance with the progress of the TCC flow. As a result, after a failure occurs in the proxy device and the restart is performed, the processing of the undecided transaction can be executed in accordance with the flag. Hereinafter, processing contents are specifically described.

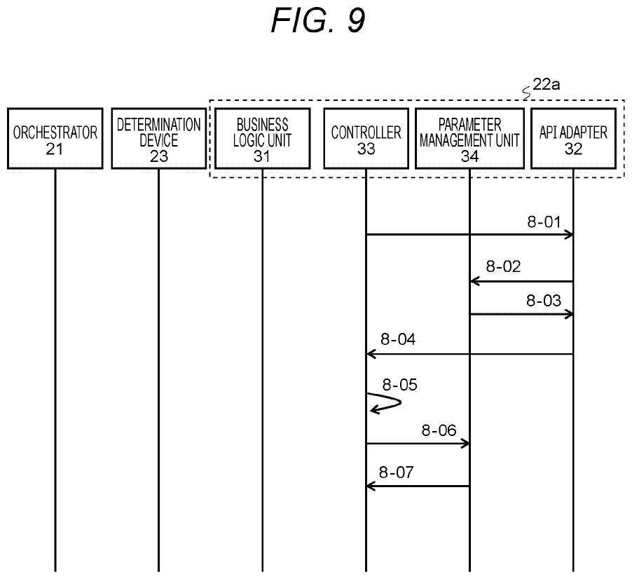

Next, a control method for the undecided transaction after a failure occurs in the transaction control system 10 during the processing of a transaction and the system is restarted is described with reference to FIGS. 9 to 11. The following describes a case where a failure occurs in the proxy device 22a and the proxy device 22a is restarted, but the configuration in which the failure occurs is not limited to the proxy device 22a.

FIG. 9 is a flowchart illustrating an operation procedure of the transaction control system with respect to the undecided transaction in a case where a flag indicates any of Try, TryOK, or TryNG when the proxy device is restarted. In step 8-01, the controller 33 transmits an instruction to execute initialization processing to the API adapter 32 when the proxy device is restarted. In steps 8-02 and 8-03, the 1 API adapter 32 reads the undecided transaction list 42 from the perpetuation unit 35 via the parameter management unit 34. In step 8-04, the API adapter 32 transmits the undecided transaction list 42 to the controller 33.

In step 8-05, the controller 33 refers to the flag of the undecided transaction described in the undecided transaction list 42. In a case where a plurality of undecided transactions is described in the undecided transaction list 42, the controller 33 refers to the flag of each of the plurality of undecided transactions. With reference to FIG. 9, a case where the flag referred to in step 8-05 indicates Try, TryOK, or TryNG will be described.

In steps 8-06 and 8-07, the controller 33 refers to the parameter list 41 saved in the perpetuation unit 35 via the parameter management unit 34, and deletes the parameter group in association with the ID of a target undecided transaction from the perpetuation unit 35. Further, the controller 33 deletes the ID of the target undecided transaction and the flag of the set having the ID identical to the ID of the target undecided transaction from the undecided transaction list 42.

When a failure occurs in the proxy device 22a in a case where the flag of the undecided transaction indicates any of Try, TryOK, or TryNG, the communication between the orchestrator 21 and the business logic unit 31 is disconnected, and the business logic unit 31 cannot transmit, to the orchestrator 21, a response to the Try request. Therefore, if the orchestrator 21 cannot receive the response from the proxy device 22a within a predetermined time after the transmission of the Try request, the processing is completed as timeout. As a result, the proxy device 22a cannot continue the processing of the undecided transaction even if the proxy device 22a is restarted after the failure occurs. As a result, as the initialization processing for the undecided transaction, the controller 33 needs to delete the parameter group stored in the perpetuation unit 35 for the undecided transaction, and delete the ID of the undecided transaction list and the flag of the same combination as the ID of the undecided transaction list.

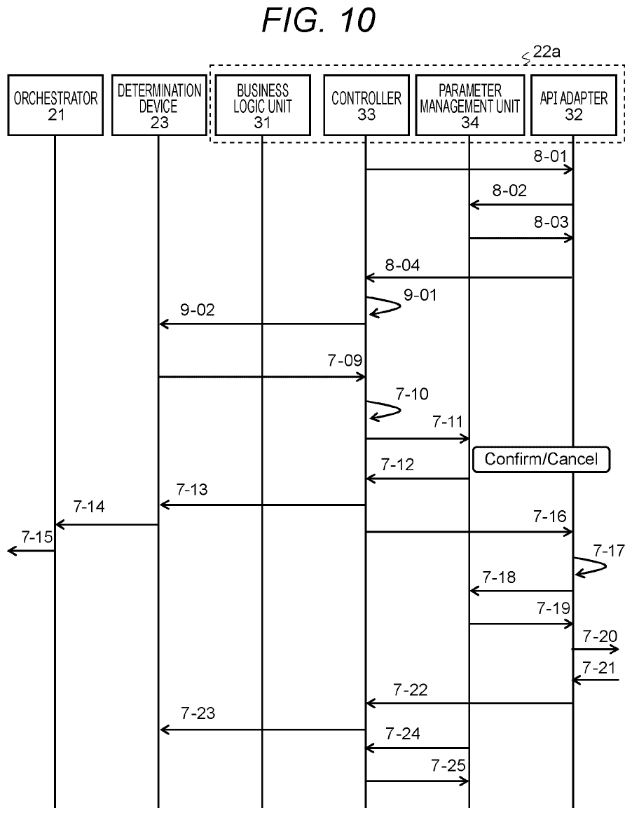

FIG. 10 is a flowchart illustrating an operation procedure of the transaction control system with respect to an undecided transaction in a case where the flag indicates Commit or Rollback when the proxy device is restarted. The undecided transaction having a flag value is Commit or Rollback can continue from transmission of the Commit vote or Rollback vote from the controller 33 to the determination device 23.

Since the processing in steps 8-01 to 8-04 illustrated in FIG. 10 is similar to the processing in steps 8-01 to 8-04 described with reference to FIG. 9, the detailed description thereof is omitted. Further, since the processing in steps 7-09 to 7-25 illustrated in FIG. 10 is similar to the processing in steps 7-09 to 7-25 described with reference to FIG. 8, the detailed description thereof is omitted.

In step 9-01, the controller 33 refers to the flag of the undecided transaction designated by the transaction ID among the undecided transactions described in the undecided transaction list 42. With reference to FIG. 10, a case where the flag referred to in step 9-10 indicates Commit or Rollback is described. In step 9-02, the controller 33 transmits the Commit vote to the determination device 23 in a case where the flag indicates Commit, and transmits the Rollback vote to the determination device 23 in a case where the flag indicates Rollback.

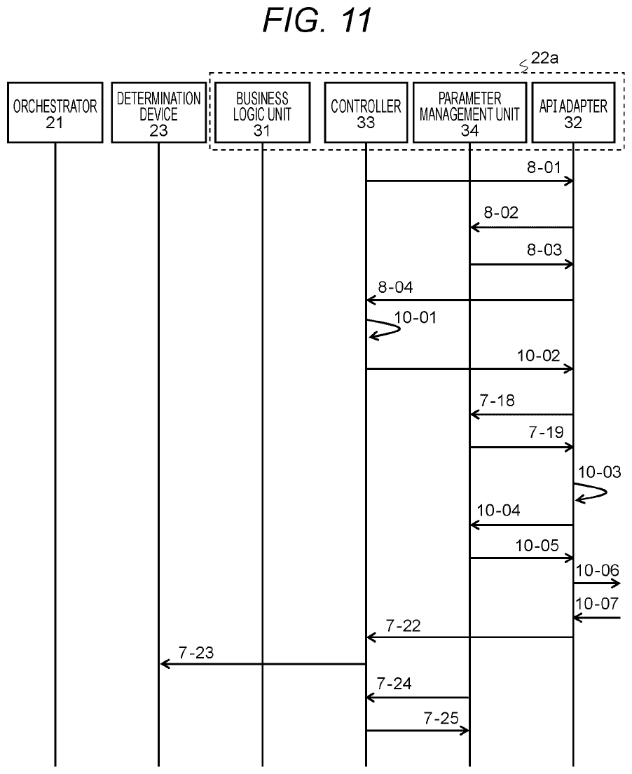

FIG. 11 is a flowchart illustrating an operation procedure of the transaction control system for an undecided transaction in a case where the flag indicates Confirm or Cancel when the proxy device is restarted. An undecided transaction having a flag value of Confirm or Cancel may continue from transmission of an instruction to implement Confirm or Cancel from the controller 33 to the API adapter 32.

Since the processing in steps 8-01 to 8-04 illustrated in FIG. 11 is similar to the processing in steps 8-01 to 8-04 described with reference to FIG. 9, the detailed description thereof is omitted. Further, since the processing in steps 7-18, 7-19, and 7-22 to 7-25 illustrated in FIG. 11 is similar to the processing in steps 7-18, 7-19 and 7-22 to 7-25 described with reference to FIG. 8, the detailed description thereof is omitted.

In step 10-01, the controller 33 refers to the flag of the undecided transaction described in the undecided transaction list 42. With reference to FIG. 11, a case where the flag referred to in step 10-01 indicates Confirm or Cancel is described. In step 10-02, the controller 33 transmits an instruction to implement the Confirm request or an instruction to implement the Cancel request to the API adapter 32. In step 10-03, the API adapter 32 determines whether an idempotence ID for the Confirm request or the Cancel request is included in the parameter group read in step 7-18. The API adapter 32 generates an idempotence ID when no idempotence ID is included in the parameter group, and does not generate a new idempotence ID when the idempotence ID is included in the parameter group. This is because, when a new idempotence ID is generated, the external server 12a is caused to multiply execute Confirmation request or Cancel request.

In a case where the API adapter 32 generates a new idempotence ID, the API adapter stores the idempotence ID in the perpetuation unit 35 in association with the ID of a target undecided transaction via the parameter management unit 34 in steps 10-04 and 10-05. In step 10-06, the API adapter 32 transmits the Confirm request or the Cancel request to the external server 12a. In step 10-07, the API adapter 32 receives, from the external server 12a, a response to the request transmitted to the external server 12a. Here, in a case where the timing of the failure occurrence in the proxy device 22a is after the Confirm request or the Cancel request is transmitted from the proxy device 22a to the external server 12a, the response from the external server 12a to the proxy device 22a becomes an error related to the idempotence, but this does not particularly cause a problem.

As described with reference to FIGS. 6 to 11, a flag indicating the progress is added to the undecided transaction in accordance with the progress of the TCC flow, thereby making it possible to branch the initialization processing after restart at the time of failure occurrence in the proxy device. In particular, when the flag indicates Commit, the undecided d transaction can be rolled forward, thereby improving the success rate of the transaction.

The transaction control system 10 according to the first embodiment includes the orchestrator 21, the plurality of proxy devices 22a and 2b. The orchestrator 21 generates the Try request for confirming whether a transaction is executable before causing the plurality of external servers 12a and 12b to execute the transaction, which is a series of processing generated by the user's request. Each of the plurality of proxy devices s 22a and 22b is provided corresponding to the external server, and records a flag indicating the progress for each undecided transaction in accordance with the progress of the processing flow including the generation of the Try request through the decision of the transaction. After restarting, each of the plurality of proxy devices 22a and 22b determines whether to continue the processing for the undecided transaction in accordance with the flag.

According to the first embodiment, the flag indicating progress during the processing flow including the generation of the Try request through the decision of the transaction is recorded for the undecided transaction in accordance with the progress. For example, regarding the transaction, in the case of the conventional TCC flow, the managed state has two phases, whereas in the first embodiment, an intermediate state between the two phases is also recorded in a flag. Since the state during the undecided transaction is more finely recorded in the flag, the undecided transaction is more likely to be rolled forward due to the progress recorded in the flag at the time of system restart. As a result, the processing for rolling back the undecided transaction is suppressed.

In the TCC flow, by recording the progress in which the undecided transaction can be rolled forward, the transaction that has been conventionally rolled back can be rolled forward. Therefore, the success rate of a transaction improves.

### Second Embodiment

A configuration of the transaction control system according to a second embodiment is described with reference to the drawings. In the second embodiment, the same components as those described in the first embodiment are denoted by the same reference numerals, and the detailed description thereof is omitted.

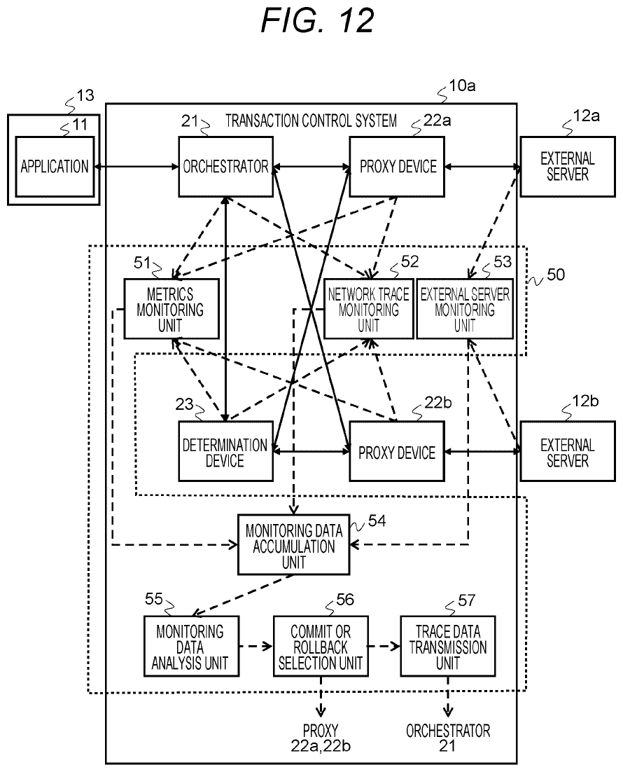

FIG. 12 is a block diagram illustrating one configuration example of the transaction control system according to the second embodiment. A transaction control system 10a of the second embodiment includes a monitoring device 50 in addition to the configuration of the transaction control system 10 illustrated in FIG. 1. The monitoring device 50 includes a metrics monitoring unit 51, a network trace monitoring unit 52, an external server monitoring unit 53, a monitoring data accumulation unit 54, a monitoring data analysis unit 55, a Commit or Rollback selection unit 56, and a trace data transmission unit 57. One example of a hardware configuration of the monitoring device 50 is similar to the configuration described with reference to FIG. 5, and thus a detailed description thereof is omitted.

In the second embodiment, in a case where the proxy device 22a and the proxy device 22b record Commit in the flag of an undecided transaction and are then restarted, a notification of the restart is transmitted to the Commit or Rollback selection unit 56.

The monitoring device 50 determines whether to continue the processing of an undecided transaction based on the contents of the progress indicated by the flag described in the first embodiment and monitoring results of the plurality of devices that controls a transaction. The plurality of devices that controls a transaction is the orchestrator 21, the proxy device 22a, the proxy device 22b, and the determination device 23 in the transaction control system 10a. Hereinafter, a configuration of each unit in the monitoring device 50 is described.

The metrics monitoring unit 51 monitors operating states based on a plurality of monitoring items, such as a CPU use rate and a memory use amount of each of the plurality of devices that controls a transaction. The metrics monitoring unit 51 outputs control device monitoring data, which is monitoring data indicating the operating states of the plurality of devices, to the monitoring data accumulation unit 54.

The network trace monitoring unit 52 monitors communication environment such as performance of a network connecting the plurality of devices that controls a transaction and presence of a failure on a path. The network trace monitoring unit 52 outputs communication monitoring data, which is monitoring data indicating a communication environment of the network, to the monitoring data accumulation unit 54.

The external server monitoring unit 53 monitors operating states as to whether the plurality of external servers including the external server 12a and the external server 12b are normally operating. The external server monitoring unit 53 outputs external server monitoring data, which is monitoring data indicating the operating states of the plurality of external servers, to the monitoring data accumulation unit 54.

The monitoring data accumulation unit 54 receives the control device monitoring data from the metrics monitoring unit 51, receives the communication monitoring data from the network trace monitoring unit 52, and receives the external server monitoring data from the external server monitoring unit 53. The monitoring data accumulation unit 54 accumulates the received control device monitoring data, communication monitoring data, and external server monitoring data. The monitoring data accumulation unit 54 receives the plurality of pieces of monitoring data at a predetermined cycle tp. The monitoring data accumulation unit 54 may update the accumulated data to new data each time the plurality of pieces of monitoring data is received at the cycle tp. The monitoring data accumulation unit 54 includes, for example, a database. Hereinafter, the plurality of pieces of monitoring data including the control device monitoring data, the communication monitoring data, and the external server monitoring data accumulated in the monitoring data accumulation unit 54 is referred to as system monitoring data.

Upon receiving an instruction to analyze the system monitoring data accumulated in the monitoring data accumulation unit 54 from the Commit or Rollback selection unit 56, the monitoring data analysis unit 55 refers to the system monitoring data. Based on the system monitoring data accumulated in the monitoring data accumulation unit 54, the monitoring data analysis unit 55 analyzes whether a failure has occurred in the plurality of devices that controls a transaction and whether a delay or failure has occurred in the network. For example, a predetermined system monitoring tool or business intelligence tool may be used for the analysis processing executed by the monitoring data analysis unit 55. Based on the system monitoring data accumulated in the monitoring data accumulation unit 54, the monitoring data analysis unit 55 outputs, to the Commit or Rollback selection unit 56, a result of analyzing whether a failure has occurred in the plurality of devices that controls a transaction or whether a delay or a failure has occurred in the network as the monitored result.

Upon receiving the notification of restart from the proxy device 22a or the proxy device 22b, the Commit or Rollback selection unit 56 instructs the trace data transmission unit 57 to transmit trace data. The trace data is test data for confirming a communication state and a communication path. Upon receiving the notification of the restart from the proxy device 22a or the proxy device 22b, the Commit or Rollback selection unit 56 instructs the monitoring data analysis unit 55 to analyze the system monitoring data accumulated in the monitoring data accumulation unit 54. The Commit or Rollback selection unit 56 acquires, from the monitoring data analysis unit 55, a result of analyzing whether a failure has occurred in the plurality of devices that controls a transaction and a delay and a failure have occurred in the network as monitored results. For example, in a case where the CPU use rate of the proxy device 22a increases, or in a case where a delay or failure has occurred in the network around the proxy device 22a, the Commit or Rollback selection unit 56 instructs the proxy device 22a to perform Rollback vote. On the other hand, in a case where the CPU use rate of the proxy device 22a is smaller than or equal to a predetermined threshold, and in a case where no delay or failure has occurred in the network around the proxy device 22a, the Commit or Rollback selection unit 56 instructs the proxy device 22a to perform the Commit vote.

The trace data transmission unit 57 transmits trace data to the orchestrator 21 when the Commit or Rollback selection unit 56 gives an instruction to transmit the trace data. The orchestrator 21 transfers the trace data received from the trace data transmission unit 57 to the plurality of devices that controls a transaction. As a result, the trace data is sequentially transmitted to the plurality of devices in the transaction control system 10a after the restart, and the network trace monitoring unit 52 can confirm the state of the network.

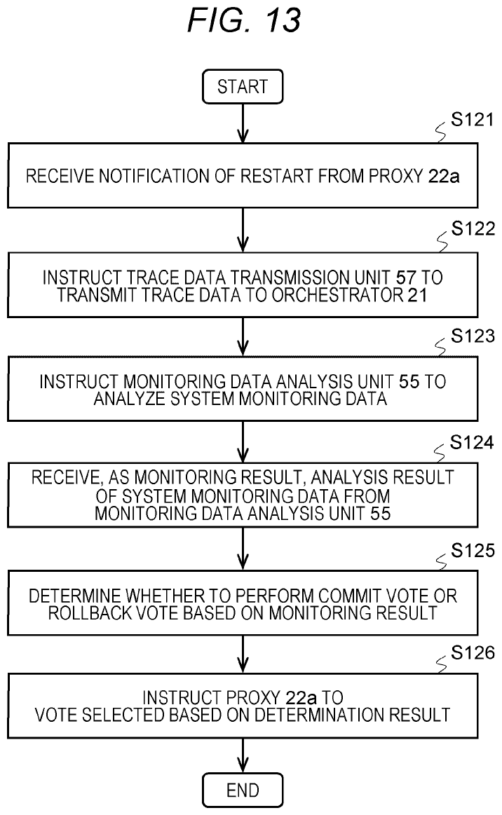

Next, the transaction control system 10a according to the second embodiment is described. Also in the second embodiment, the transaction control system 10a records a flag in accordance with the progress in the TCC flow for each transaction as in the first embodiment, but the description thereof is omitted. FIG. 13 is a flowchart illustrating an operation procedure of a Commit or Rollback determination unit in the transaction control system according to the second embodiment. Here, a case where a failure has occurred in the proxy device 22a is described.

The proxy device 22a is restarted after the failure occurs. The proxy device 22a refers to the undecided transaction list 42 in the initialization processing after restart. In a case where there is an undecided transaction having a flag value of Commit among the undecided transactions included in the undecided transaction list 42, the proxy device 22a transmits a notification of restart to the Commit or Rollback selection unit 56.

In step S121, the Commit or Rollback selection unit 56 receives a notification of restart from the proxy device 22a. In step S122, the Commit or Rollback selection unit 56 instructs the trace data transmission unit 57 to transmit the trace data to the orchestrator 21. In step S123, the Commit or Rollback selection unit 56 instructs the monitoring data analysis unit 55 to analyze the system monitoring data. In step S124, the Commit or Rollback selection unit 56 receives the analysis result of the system monitoring data as the monitoring result from the monitoring data analysis unit 55.

In step S125, the Commit or Rollback selection unit 56 determines whether to perform the Commit vote or Rollback vote in accordance with the monitoring result received from the monitoring data analysis unit 55. In step S126, the Commit or Rollback selection unit 56 instructs the proxy device 22a to perform a vote selected in accordance with the determination result. Specifically, in a case where the monitoring result indicates that the resource use states and network states of the plurality of devices that controls a transaction are stable, the Commit or Rollback selection unit 56 instructs the proxy device 22a to perform the Commit vote as the determination result. On the other hand, in a case where the monitoring result indicates that the resource use states and network states of the plurality of devices that controls a transaction are unstable, the Commit or Rollback selection unit 56 instructs the proxy device 22a to perform the Rollback vote as the determination result.

As described with reference to FIGS. 12 and 13, in a case where the flag of the undecided transaction indicates Commit and the monitoring result indicates that the system is stable, the transaction control system 10a performs Rollforward on the undecided transaction. On the other hand, in a case where the monitoring result indicates that the system is unstable even if the flag of the undecided transaction indicates Commit, the transaction control system 10a performs Rollback on the undecided transaction. The time until the decision of the transaction is shortened as compared with the case where the Rollback processing is required after Rollforward is forcibly performed when with the system being unstable.

According to the second embodiment, the monitoring device 50 monitors the system, and selects Rollforward for an undecided transaction when the flag of the undecided transaction indicates Commit and the monitoring result indicates that the system is stable. On the other hand, the monitoring device 50 selects Rollback for the undecided transaction in a case where the monitoring result indicates that the system is unstable even when the flag of the undecided transaction indicates Commit. In a case where the system is unstable, Rollback is performed on the undecided transaction. The time until the decision of the transaction can be shortened as compared with the case where the Rollback processing is required after Rollforward is forcibly performed with the system being unstable. Therefore, when the system is unstable, the response to the request from the user is improved by performing Rollback on the undecided transaction without forcibly performing Rollforward.

Note that, in the present embodiment, an administrator of the transaction control system 10 or 10a can select whether to cause the system to perform the transaction control method. For example, the administrator may perform an operation via the input unit 72a to be capable of setting on or off a progress management function using the flag of an undecided transaction in the middleware of the transaction control.

Further, in the present embodiment, the case where the configuration for controlling a transaction is the system has been described, but the transaction control system 10 or 10a may be an information processing device such as a single computer. In this case, the processor 73 illustrated in FIG. 5 executes the program stored in the memory 74, thereby executing the functions of the orchestrator 21, the proxy device 22a, the proxy device 22b, and the determination device 23. The program corresponds to the middleware that controls a transaction.

Further, in the second embodiment, the case where the monitoring device 50 is a single information processing device has been described, but the configuration of the monitoring device 50 is not limited to a single information processing device. For example, the metrics monitoring unit 51, the network trace monitoring unit 52, the external server monitoring unit 53, the monitoring data accumulation unit 54, the monitoring data analysis unit 55, the Commit or Rollback selection unit 56, and the trace data transmission unit 57 illustrated in FIG. 12 may be configured respectively by individual information processing devices.

The above-described embodiments are examples for describing the present invention, and the scope of the present invention is not intended to be limited only to the embodiments. A person skilled in the art can carry out the present invention in various other aspects without departing from the scope of the present invention.

In addition, the above-described embodiments include the following items. However, the items included in the present embodiment are not limited to the following items.

### Item 1

A transaction control system includes:
an orchestrator that generates a Try request for confirming whether to execute a transaction, the transaction being a series of processing generated based on a request from a user, before causing a plurality of external servers to execute the transaction; and
a plurality of proxy devices provided correspondingly to the plurality of external servers, the plurality of proxy devices each recording a flag indicating progress of a processing flow including generation of the Try request through decision of the transaction for each undecided transaction in accordance with the progress,
wherein the plurality of proxy devices each determine whether to continue the processing of the undecided transaction based on the flag after restart.

According to this, the flag indicating progress during the processing flow including the generation of the Try request through the decision of the transaction is recorded for the undecided transaction in accordance with the progress. Since the state during the undecided transaction is more finely recorded in the flag, the undecided transaction is more likely to be rolled forward due to the progress recorded in the flag at the time of system restart. As a result, the processing for rolling back the undecided transaction is suppressed.

### Item 2

The transaction control system described in item 1, further includes a determination device that determines whether to execute the transaction based on a vote of the Try request in the plurality of proxy devices and transmits determination results respectively to the plurality of proxy devices,
wherein the plurality of proxy devices each,
upon receiving a response to the Try request from corresponding one of the plurality of external servers, perform a vote of Commit or Rollback on the determination device in accordance with the response, the Commit meaning that provisional execution of the transactions is successful, the Rollback meaning a return to a state before the provisional execution of the transaction, and
record, as the flag of the undecided transaction, the Commit or the Rollback based on a content of the vote.

According to this, since the vote result by each response in the plurality of external servers to the Try request is also recorded in the flag as the progress, the processing of the undecided transaction can be continued from the voting result when the system is restarted.

### Item 3

In the transaction control system described in item 1 or 2, the plurality of proxy devices each enable the flag between transmission of the response to the Try request, the response being received from corresponding one of the plurality of the external servers, to the orchestrator and reception of the determination result from the determination device.

According to this, since the response to the Try request through the determination result in the determination device are effectively recorded as the progress, the processing for the undecided transaction can be continued from any of the response result, the vote result, and the determination result.

### Item 4

In the transaction control system described in any one of items 1 to 3, the plurality of proxy devices each
refer to the flag given to the undecided transaction after the restart, and
do not continue the processing for the undecided transaction in a case where, as a result of reference to the flag, the flag indicates a content of the response to the Try request, continues the processing for the undecided transaction from the vote in the determination device in a case where the flag indicates the Commit or the Rollback as the vote, and continues the processing for the undecided transaction from Confirm or Cancel in a case where the flag indicates the Confirm or Cancel.

According to this, in a case where the flag of the undecided transaction indicates Commit or Rollback, the undecided transaction can be continued from the processing of a vote from the proxy device to the determination device. In a case where the flag of the undecided transaction indicates Confirmed or Canceled, the proxy device can continue from the processing of Confirm or Cancel. Therefore, it is unnecessary to execute the Rollback processing on a part of the undecided transaction that has been the target of the Rollback processing.

### Item 5

In the transaction control system described in any one of items 1 to 4, the plurality of proxy devices each have a list in which a combination of an identifier and the flag of the undecided transaction in association with the undecided transaction is recorded.

As a result, the information about the flag corresponding to the progress of the TCC flow is recorded in the list in association with the identifier of the undecided transaction. Therefore, even if a plurality of transactions is performed in parallel, the progress status in the TCC flow is recorded in the list for each of the plurality of transactions.

### Item 6

The transaction control system described in any one of items 1 to 5, further includes a monitoring device that determines whether to continue the processing for the undecided transaction based on the content of the progress indicated by the flags and monitoring results in the orchestrator, the plurality of proxy devices, and the determination device.

As a result, a determination is made whether to continue the processing for the undecided transaction based on not only the progress indicated by the flag but also the monitoring results. Therefore, in a case where the undecided transaction is subject to the Rollback processing with the system being unstable, the time until the transaction is decided can be shortened as compared with a case where the Rollback processing is required after forced Rollforward.

### Item 7

In the transaction control system described in Item 6, the monitoring device includes
a metrics monitoring unit that monitors operating states of a plurality of devices including the orchestrator, the plurality of proxy devices, and the determination device, and outputs monitoring data indicating the operating states,
a network trace monitoring unit that monitors a communication environment of a network connecting the plurality of devices and outputs monitoring data indicating the communication environment,
an external server monitoring unit that monitors operating states as to whether the plurality of external servers is operating normally and outputs the monitoring data indicating the operating states of the plurality of external servers,
a monitoring data accumulation unit that accumulates the monitoring data received from the metrics monitoring unit, the network trace monitoring unit, and the external server monitoring unit,
a monitoring data analysis unit that analyzes whether a failure has occurred in the plurality of devices and a delay and a failure have occurred in the network, based on the plurality of pieces of monitoring data accumulated in the monitoring data accumulating unit, and outputs an analysis result as the monitoring result, and
a selection unit that determines whether to continue the processing of the undecided transaction based on the content of the progress indicated by the flag of the undecided transaction and the monitoring result received from the monitoring data analysis unit.

As a result, the monitoring result that assists the determination whether to continue the undecided transaction includes not only the operating states of the plurality of devices including the orchestrator involved in the control of the transaction but also the analysis results of the communication environment between the plurality of devices and the operating state of the external server. Therefore, the state of the system is reflected by the determination as to whether to continue the undecided transaction.

### Reference Signs List

10, 10a distributed transaction control system

11 application

12a external server

12b external server

13 information processing terminal

21 orchestrator

22a proxy device

22b proxy device

23 determination device

31 business logic unit

32 API adapter

33 controller

34 parameter management unit

35 perpetuation unit

41 parameter list

42 undecided transaction list

51 metrics monitoring unit

52 network trace monitoring unit

53 external server monitoring unit

54 monitoring data accumulation unit

55 monitoring data analysis unit

56 Commit or Rollback selection unit

57 trace data transmission unit

70 control unit

71 storage unit

72a input unit

72b output unit

73 processor

74 memory

1. A transaction control system, comprising:
an orchestrator that generates a Try request for confirming whether to execute a transaction, the transaction being a series of processing generated based on a request from a user, before causing a plurality of external servers to respectively execute the transaction; and
a plurality of proxy devices provided correspondingly to the plurality of external servers, the plurality of proxy devices each recording a flag indicating progress of a processing flow including generation of the Try request through decision of the transaction for an undecided transaction in accordance with the progress,
wherein the plurality of proxy devices each determine whether to continue the processing of the undecided transaction based on the flag after restart.

2. The transaction control system according to claim 1, further comprising a determination device that determines whether to execute the transaction based on a vote of the Try request in the plurality of proxy devices and transmits determination results respectively to the plurality of proxy devices,
wherein the plurality of proxy devices each,
upon receiving a response to the Try request from corresponding one of the plurality of external servers, perform a vote of Commit or Rollback on the determination device in accordance with the response, the Commit meaning that provisional execution of the transaction is successful, the Rollback meaning a return to a state before the provisional execution of the transaction, and
record, as the flag of the undecided transaction, the Commit or the Rollback based on a content of the vote.

3. The transaction control system according to claim 2, wherein the plurality of proxy devices each enable the flag between transmission of the response to the Try request, the response being received from corresponding one of the plurality of the external servers, to the orchestrator and reception of the determination result from the determination device.

4. The transaction control system according to claim 3, wherein the plurality of proxy devices each
refer to the flag given to the undecided transaction after the restart, and
do not continue the processing for the undecided transaction in a case where, as a result of reference to the flag, the flag indicates a content of the response to the Try request, continues the processing for the undecided transaction from the vote in the determination device in a case where the flag indicates the Commit or the Rollback as the vote, and continues the processing for the undecided transaction from Confirm or Cancel in a case where the flag indicates the Confirm or Cancel.

5. The transaction control system according to claim 4, wherein the plurality of proxy devices each have a list in which a combination of an identifier and the flag of the undecided transaction in association with the undecided transaction is recorded.

6. The transaction control system according to claim 3, further comprising a monitoring device that determines whether to continue the processing for the undecided transaction based on the content of the progress indicated by the flag and monitoring results in the orchestrator, the plurality of proxy devices, and the determination device.

7. The transaction control system according to claim 6, wherein the monitoring device includes
a metrics monitoring unit that monitors operating states of a plurality of devices including the orchestrator, the plurality of proxy devices, and the determination device, and outputs monitoring data indicating the operating states,
a network trace monitoring unit that monitors a communication environment of a network connecting the plurality of devices and outputs monitoring data indicating the communication environment,
an external server monitoring unit that monitors operating states as to whether the plurality of external servers is operating normally and outputs the monitoring data indicating the operating states of the plurality of external servers,
a monitoring data accumulation unit that accumulates the monitoring data received from the metrics monitoring unit, the network trace monitoring unit, and the external server monitoring unit,
a monitoring data analysis unit that analyzes whether a failure has occurred in the plurality of devices and a delay and a failure have occurred in the network, based on the plurality of pieces of monitoring data accumulated in the monitoring data accumulation unit, and outputs an analysis result as the monitoring result, and
a selection unit that determines whether to continue the processing for the undecided transaction based on the content of the progress indicated by the flag of the undecided transaction and the monitoring result received from the monitoring data analysis unit.

8. A transaction control method for causing a plurality of external servers to execute a transaction being a series of processing generated based on a request from a user, the method comprising:
generating a Try request for confirming whether to execute the transaction before causing the plurality of external servers to execute the transaction;
recording, correspondingly to each of the plurality of external servers, a flag indicating progress of a processing flow including generation of the Try request through decision of the transaction for each h undecided transaction in accordance with the progress; and
determining whether to continue the processing for the undecided transactions based on the flag after restart.

9. A program that causes a computer to execute operations, the computer causing a plurality of external servers to execute a transaction being a series of processing generated based on a request from a user, the operations comprising:
generating a Try request for confirming whether to execute the transaction before causing the plurality of external servers to execute the transaction;
recording, correspondingly to each of the plurality of external servers, a flag indicating progress of a processing flow including generation of the Try request through decision of the transaction for each undecided transaction in accordance with the progress; and
determining whether to continue the processing for the undecided transaction based on the flags after restart.
